(19) United States
(12) Patent Application Publication
(10) Pub. No.: US 2024/0182798 A1
(43) Pub. Date: Jun. 6, 2024

(54) PROCESS FOR HYDROPROCESSING MATERIALS FROM RENEWABLE SOURCES

(71) Applicant: SHELL USA, INC., Houston, TX (US)

(72) Inventors: Nicolaas VAN DIJK, Amsterdam (NL); Roy Léon Bemard HENKET, Amsterdam (NL); Julien SIGAUD, Amsterdam (NL)

(21) Appl. No.: 18/555,143

(22) PCT Filed: May 9, 2022
(86) PCT No.: PCT/US2022/028262

§ 371 Date: Oct. 12, 2023

(30) Foreign Application Priority Data
May 13, 2021 (EP) 21173759.8

(51) Int. Cl. C10G 49/00; B01D 29/17; B01D 39/20; B01J 8/00; B01J 8/04

(52) U.S. Cl. CPC C10G 49/002; B01D 29/17; B01D 39/2027; B01D 39/2068; B01J 8/0085; B01J 8/0453; C10G 2300/4006

(57) ABSTRACT

A process for hydroprocessing a renewable feedstock in a fixed-bed reactor system having at least one catalytic bed involves directing a downward flow of the renewable feedstock to a filtering zone having top-open interstitial portions to receive the downward flow and top-covered annular portions that are in fluid communication with a headspace between the filtering zone and a catalytic zone. The feedstock flows from the interstitial portions to the annular portions through a filtering material disposed between the interstitial portions and the annular portions, resulting in a filtered feedstock, which then flows to the catalytic zone. In the catalytic zone, filtered feedstock is reacted under hydroprocessing conditions sufficient to cause a reaction selected from the group consisting of hydrogenation, hydrodeoxygenation, hydrodenitrogenation, hydrodesulphurization, hydrodemetalation, hydrocracking, hydroisomerization, and combinations thereof.

### FIELD OF THE INVENTION

The present invention relates to the field of producing low carbon fuel and/or chemicals from renewable sources and, in particular, to a process for hydroprocessing materials from renewable sources.

### BACKGROUND OF THE INVENTION

The increased demand for energy resulting from worldwide economic growth and development has contributed to an increase in concentration of greenhouse gases in the atmosphere. This has been regarded as one of the most important challenges facing mankind in the 21st century. To mitigate the effects of greenhouse gases, efforts have been made to reduce the global carbon footprint. The capacity of the earth's system to absorb greenhouse gas emissions is already exhausted, and under the Paris climate agreement, current emissions must be fully stopped until around 2070. To realize these reductions, the world is transitioning away from solely conventional carbon-based fossil fuel energy carriers. A timely implementation of the energy transition requires multiple approaches in parallel. For example, energy conservation, improvements in energy efficiency and electrification may play a role, but also efforts to use renewable resources for the production of fuels and fuel components and/or chemical feedstocks.

For example, vegetable oils, oils obtained from algae, and animal fats are seen as new sources for low carbon fuel production. Also, deconstructed materials are seen as a potential source for low carbon renewable fuels materials, such as pyrolyzed recyclable materials or wood.

Renewable materials may comprise materials such as triglycerides with very high molecular mass and high viscosity, which means that using them directly or as a mixture in fuel bases is problematic for modern engines. On the other hand, the hydrocarbon chains that constitute, for example, triglycerides are essentially linear and their length (in terms of number of carbon atoms) is compatible with the hydrocarbons used in/as fuels. Thus, it is attractive to transform triglyceride-comprising feeds in order to obtain good quality fuel components. As well, renewable feedstocks may comprise unsaturated compounds and/or oxygenates that are unsaturated compounds.

The renewable feedstocks are therefore hydrotreated to remove oxygen, sulphur, and nitrogen.

Hydrogenation of unsaturated compounds, such as diolefins, is highly exothermic. Hydrodeoxygenation is also an exothermic reaction. Renewable feedstocks with a high content of unsaturated compounds and/or oxygenates will generate a significant heat release during hydroprocessing. The high exothermicity will result in a large temperature increase over the catalyst beds in the reactor, if no measures are taken.

Currently, the high exothermicity in hydroprocessing of renewable materials is generally dealt with by application of a high liquid recycle rate to the reactor inlet in combination with a significant amount of liquid quench. The recycle and/or quench streams are used to dilute the reactivity of the fresh feed and provide a heat sink for the exothermic reaction.

For example, Myllyoja et al. (U.S. Pat. No. 8,859,832B2, 14 Oct. 2014) describes a process for the manufacture of diesel range hydrocarbons wherein a feed is hydrotreated in a hydrotreating step and isomerized in an isomerization step. The feed, comprising fresh feed containing more than 5 wt % of free fatty acids and at least one diluting agent, is hydrotreated at a reaction temperature of 200-400° C., in a hydrotreating reactor in the presence of catalyst, and the ratio of the diluting agent/fresh feed is 5-30:1.

As another example, Marker et al. (U.S. Pat. No. 7,982,076B2, 19 Jul. 2011), describes a process for producing diesel boiling range fuel from renewable feedstocks, such as plant oils, animal fats and oils, and greases, which involves treating a renewable feedstock by hydrogenating and hydrodeoxygenating to provide a diesel boiling range fuel hydrocarbon product. In the process of Marker et al., a portion of the hydrocarbon product is recycled to the treatment zone to increase the hydrogen solubility of the reaction mixture. The volume ratio of recycle to feedstock is in the range of about 2:1 to about 8:1. According to Marker et al., one benefit of the hydrocarbon recycle is to control the temperature rise across the individual beds. Reportedly, without recycling, after some time the level of oxygen in the product started to continuously increase indicating the catalyst had significantly deactivated and triglycerides were no longer sufficiently reacted.

Using product for recycle and/or quench adds to the total hydraulic load of the system and to increased size of equipment. Further, it should be noted that if gas would be used as quench, the amount of gas that would be required to quench the exothermicity would be very large. Generally, these conventional solutions adversely affect the cost effectiveness and energy efficiency of the operation.

Beyond the heat generated when renewable feedstocks are contacted with hydrogen and catalyst, another problem is that renewable feedstocks are heat-sensitive. Accordingly, preheating the renewable feedstock before introduction to the hydroprocessing reactor can cause deleterious degradation of the feedstock. For example, when the feedstock has a relatively high unsaturated content, there is a tendency for the feedstock to form larger oligomers and/or polymeric compounds. As another example, when the feedstock comprises fatty acids, corrosion by-products may be formed, including deleterious levels of iron and/or organic acids.

In a conventional downflow hydroprocessing reactor, a catalyst bed is provided in a generally cylindrical manner having a cross-section substantially equal to the internal cross-section of the reactor. The liquid feedstock is typically preheated and introduced through the reactor inlet with hydrogen-containing vapor and distributed over the cross-section of the catalyst bed.

However, degradation by-products from preheating cause fouling of a top layer of the catalyst bed. In addition to the deleterious effects on the catalyst activity, the fouling also increases a pressure drop across the catalyst bed. Conventionally, the loss of catalyst activity due to fouling is managed by increasing the reactor temperature, which again adversely affects the cost and energy efficiency of the operation.

Solantie et al. (U.S. Pat. No. 9,352,292B2, 31 May 2016) describe a method and arrangement for feeding heat-sensitive material to a fixed-bed reactor by introducing the liquid feedstock to each reaction zone with a cold feed distributor and introducing a dilution recycle stream to each reaction zone with a conventional distributor. The conventional distributor is arranged above each cold feed distributor. The heat-sensitive material is thereby mixed with the product recycle stream to the desired reaction temperature before being passed to the active catalyst bed to decrease residence time and thermal side-reactions.

Solantie et al., however, do not solve the problem of needing to add recycle product to the reactor. In this case, the recycled product is added to increase the temperature so that the cold feed does not contact the catalyst at a temperature that is too low for optimal reactivity.

Particulate matter in feedstock may also have an effect on pressure drop across a catalyst bed. For example, Zahirovic et al. (U.S. Pat. No. 10,835,884B2, 17 Nov. 2020) relates to particle retaining equipment for capturing char, coke, gums, salts, debris or corrosion and erosion as iron components, and the like from feed to downflow catalytic reactors, for example in naphtha hydrotreating. A particle retention chamber is suspended from the inlet nozzle of the reactor. In one embodiment, the surface of the particulate retaining chamber is permeable and may comprise a meshed cage enclosing grading or catalytic material. Fluid flows inside the diffusing pipe and flows through the floor of the chamber. When the floor becomes saturated with particulate, it becomes impermeable to the liquid. As liquid level increases the liquid and small particulates move towards the peripheral wall of the particulate reacting chamber.

Gupta et al. (U.S. Pat. No. 6,846,469B1, 25 Jan. 2005) describes a method for extending the operation life of a fixed bed reactor. To overcome the problem of fouling or plugging the top of a catalyst bed with organometallic compounds, polymeric and carbonaceous materials and organic and inorganic particulates, Gupta et al. provide a bypass apparatus with a fixed bed of catalyst. The bypass apparatus has a first hollow cage that is perforated. A second hollow elongated member is disposed within the cage and protrudes through the top wall of the cage. When the catalyst bed is clean and no foulants have been deposited in the bed top, the feed flows through the catalyst bed instead of the bypass apparatus. As the bed top fouls during operation, resistance to flow through the bed increases and an increasing fraction of flow is bypassed to the bypass apparatus, which directs flow of the feed to the bottom of the bed. Other bypass devices are described in U.S. Pat. Nos. 3,509,043, 4,313,908 and 5,670,116.

In another approach, Grosboll et al. (U.S. Pat. Nos. 3,992,282; 3,888,633) discloses a so-called trash basket for removing particulate impurities from a fluid stream flowing into a catalyst bed having a layer of alumina balls on top. The trash basket has a flow restricting inlet to a hollow elongated basket having solid walls in a top portion and mesh walls in a bottom portion. When the catalyst bed is clean, the feed flows through the layer of alumina balls on top of the catalyst bed. During operation, the alumina balls and a top portion of the catalyst bed become fouled, causing the pressure drop to increase to a value higher than the pressure drop due to the flow restricting inlet. Fluid then enters the basket member and flows through the mesh portion into a lower part of the catalyst bed. Entrained particulates are retained inside the trash backet by the mesh portion.

Muller (U.S. Pat. No. 10,214,699B2, 26 Feb. 2019) relates to a scale collection and pre-distribution tray for capturing solid contaminants from a process stream to a downward flow reactor. An inlet channel has perforations at a lower end to discharge the fluid into the tray. The tray has a rim so that solid contaminants entrained in the fluid will settle and deposit in the tray, while liquid flows over the top of the rim into the reactor.

There remains a need for improving cost effectiveness and energy efficiency of hydroprocessing processes, and there is a need for reducing fouling of the catalyst.

### SUMMARY OF THE INVENTION

According to one aspect of the present invention, there is provided a process for hydroprocessing a renewable feedstock in a fixed-bed reactor system having at least one catalytic bed, the process comprising the steps of: introducing a renewable feedstock in a downward flow into a top portion of a fixed-bed reactor; directing the downward flow of the renewable feedstock to a filtering zone having top-open interstitial portions to receive the downward flow and top-covered annular portions that are in fluid communication with a headspace between the filtering zone and a catalytic zone; passing the downward flow from the interstitial portions to the annular portions through a filtering material disposed between the interstitial portions and the annular portions, resulting in a filtered feedstock; allowing the filtered feedstock to flow downwardly to the catalytic zone; and reacting the filtered feedstock in the catalytic zone under hydroprocessing conditions sufficient to cause a reaction selected from the group consisting of hydrogenation, hydrodeoxygenation, hydrodenitrogenation, hydrodesulphurization, hydrodemetalation, hydrocracking, hydroisomerization, and combinations thereof.

### BRIEF DESCRIPTION OF THE DRAWINGS

The process of the present invention will be better understood by referring to the following detailed description of preferred embodiments and the drawings referenced therein, in which:

FIG. 1 is a schematic illustrating one embodiment of a fixed-bed reactor for implementing the process of the present invention, the reactor having a filtering zone and a catalytic zone;

FIG. 2 is a schematic illustrating another embodiment of a fixed-bed reactor for implementing the process of the present invention, the reactor having a filtering zone and a catalytic zone, where the catalytic zone has a grading zone and a catalyst zone;

FIG. 3 is a schematic illustrating a further embodiment of a fixed-bed reactor for implementing the process of the present invention, wherein the reactor has two grading beds and a catalyst zone;

FIGS. 4A and 4B are top plan views of example embodiments of the filtering zone of FIGS. 1-3;

FIGS. 5A and 5B are side elevational cross-sectional views of one embodiment of the filtering zone of FIGS. 4A and 4B, respectively;

FIGS. 6A and 6B are side elevational cross-sectional views of another embodiment of the filtering zone of FIGS. 4A and 4B, respectively; and

FIGS. 7A-7C illustrate one embodiment of the filtering zone during operation.

### DETAILED DESCRIPTION OF THE INVENTION

The present invention provides a process for hydroprocessing a renewable feedstock that improves cost effectiveness, energy efficiency and catalyst life. As discussed above, undesirable reactions and products caused by heating renewable feedstocks to desired reaction temperatures can cause fouling of a catalyst bed. Alternatively, or in addition, renewable feedstocks may contain undesirable particulate matter. Fouling and/or particulate matter increases pressure drop across a catalyst bed and/or reduces catalyst activity.

In accordance with the present invention, the renewable feedstock is fed through a filtering zone to capture fouling and/or particulate matter before flowing to the catalytic zone. By reducing fouling and/or particulate matter before flowing to the catalyst beds, pressure drop across catalyst bed(s) in the fixed-bed reactor is reduced. In a preferred embodiment, the catalytic zone is provided with a grading zone to further protect the catalyst, thereby improving catalyst life and reducing pressure drop effects that adversely affect cost and energy efficiency. The grading zone of the present invention is also used to manage the exothermicity of the hydroprocessing reactions.

The process of the present invention is important for the energy transition and can improve the environment by producing low carbon energy and/or chemicals from renewable sources, and, in particular, from degradable waste sources, whilst improving energy efficiency of the process.

As used herein, the terms “renewable feedstock”, “renewable feed”, and “material from renewable sources” mean a feedstock from a renewable source. A renewable source may be animal, vegetable, microbial, and/or bio-derived or mineral-derived waste materials suitable for the production of fuels, fuel components and/or chemical feedstocks.

A preferred class of renewable materials are bio-renewable fats and oils comprising triglycerides, diglycerides, monoglycerides, free fatty acids, and/or fatty acid esters derived from bio-renewable fats and oils. Examples of fatty acid esters include, but are not limited to, fatty acid methyl esters and fatty acid ethyl esters. The bio-renewable fats and oils include both edible and non-edible fats and oils. Examples of bio-renewable fats and oils include, without limitation, algal oil, brown grease, canola oil, carinata oil, castor oil, coconut oil, colza oil, corn oil, cottonseed oil, fish oil, hempseed oil, jatropha oil, lard, linseed oil, milk fats, mustard oil, olive oil, palm oil, peanut oil, rapeseed oil, sewage sludge, soy oils, soybean oil, sunflower oil, tall oil, tallow, train oil, used cooking oil, yellow grease, and combinations thereof.

Another preferred class of renewable materials are liquids derived from biomass and waste liquefaction processes. Examples of such liquefaction processes include, but are not limited to, (hydro)pyrolysis, hydrothermal liquefaction, plastics liquefaction, and combinations thereof. Renewable materials derived from biomass and waste liquefaction processes may be used alone or in combination with bio-renewable fats and oils.

The process of the present invention is most particularly advantageous in the processing of feed streams comprising substantially 100% renewable feedstocks. However, in one embodiment of the present invention, renewable feedstock may be co-processed with petroleum-derived hydrocarbons. Petroleum-derived hydrocarbons include, without limitation, all fractions from petroleum crude oil, natural gas condensate, tar sands, shale oil, synthetic crude, and combinations thereof. At a renewable feed content in a range of from 1-30 wt. %, the petroleum-derived hydrocarbons will generally provide a diluting effect and/or heat sink effect. Accordingly, the present invention is more particularly advantageous for a combined renewable and petroleum-derived feedstock comprising a renewable feed content in a range of from 30 to 99 wt. %, preferably from 40 to 99 wt. %.

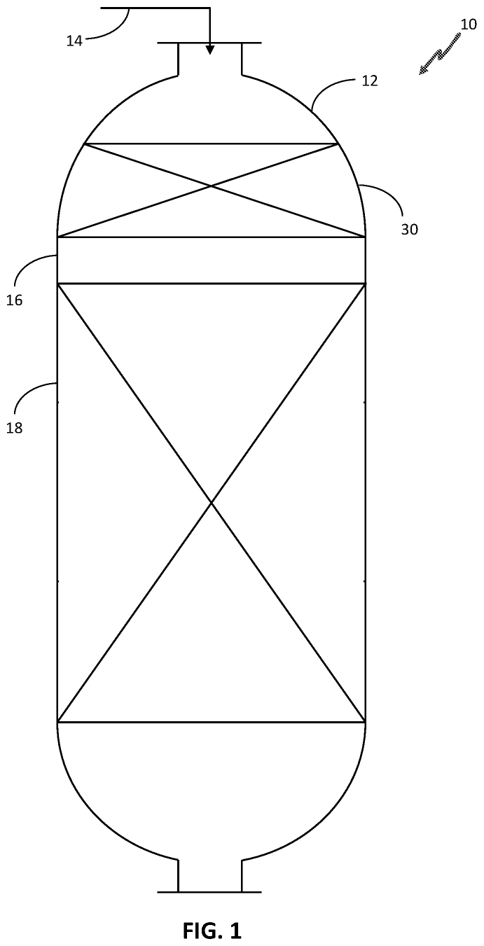

FIG. 1 illustrates one embodiment of a fixed-bed reactor 12 for implementing the process of the present invention 10. A feed stream 14 comprising a renewable feedstock is introduced to a top portion of the fixed-bed reactor 12. The feed stream 14 is introduced in a downward flow, preferably with a hydrogen-containing gas stream. The hydrogen-containing gas stream may be mixed with the feed upstream of the feed inlet to the reactor 12.

Alternatively, the hydrogen-containing gas stream may be added to the reactor 12 independently, but concurrently, with the renewable feedstock. Preferably, the downward flow is dispersed downwardly and radially outwardly and downwardly by a feed distributor, such as an impingement plate (not shown).

The feed stream 14 is directed to a filtering zone 30, which, as will be discussed in more detail below, has top-open interstitial portions to receive the downward flow and top-covered annular portions that are in fluid communication with a headspace 16 between the filtering zone 30 and a catalytic zone 18.

Catalyst in the catalytic zone 18 is selected to catalyse hydroprocessing reactions including, without limitation, hydrogenation, hydrodeoxygenation, hydrodenitrogenation, hydrodesulphurization, hydrodemetalation, hydrocracking, hydroisomerization, and combinations thereof. The catalyst may be the same throughout the catalytic zone 18; optionally the catalytic zone 18 has a mixture of catalysts. The catalytic zone 18 may comprise a single catalyst bed or multiple catalyst beds. The catalyst may be the same throughout the single catalyst bed, optionally there is a mixture of catalysts, or different catalysts may be provided in two or more layers in the catalyst bed. In an embodiment of multiple catalyst beds, the catalyst may be same or different for each catalyst bed.

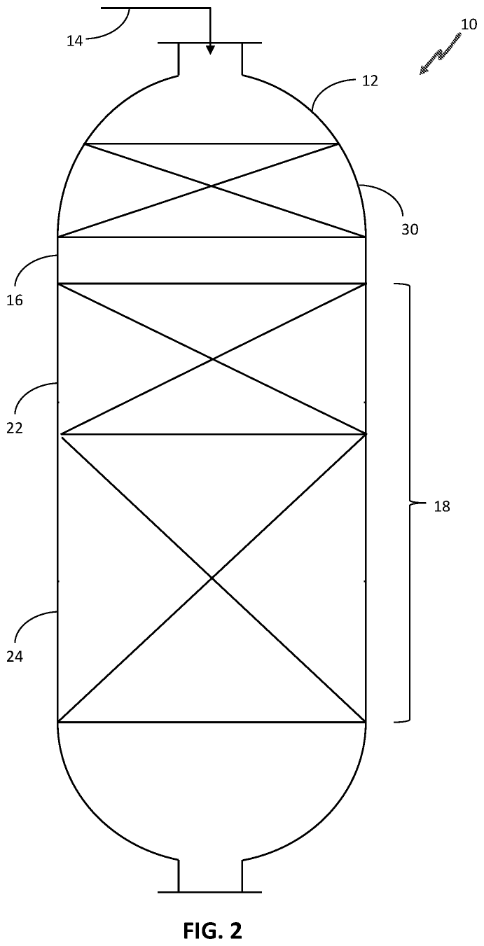

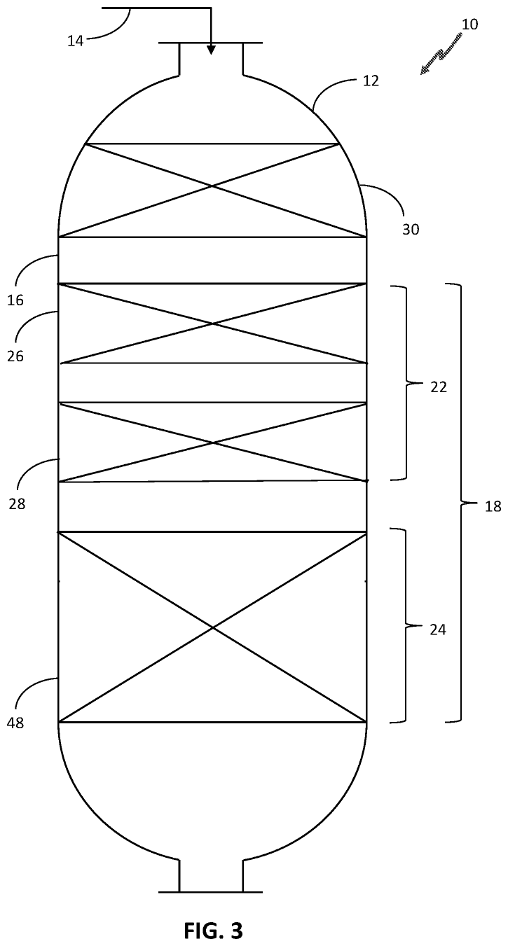

In a preferred embodiment, illustrated schematically in FIG. 2, the catalytic zone 18 is comprised of a grading zone 22 and a catalyst zone 24. The grading zone 22 and the catalyst zone 24 are depicted in FIG. 2 as being contiguous, but the grading zone 22 and the catalyst zone 24 may be in spaced-apart relationship. Each of the grading zone 22 and the catalyst zone 24 may independently be comprised of a single bed or multiple beds. For example, in the embodiment of FIG. 3, the grading zone 22 is comprised of a first grading bed 26 and a second grading bed 28.

The grading material in the grading zone 22 may be catalytically inert, have catalytic activity, or a combination thereof. A catalyst in the grading zone 22 may be the same type as, or a different catalyst than, the catalyst in the catalyst zone 24. But the catalyst in the grading zone 22 has a start-of-run catalytic activity that is less than the start-of-run catalytic activity of the catalyst in the catalytic zone 24. Preferably, the start-of-run catalytic activity of the grading zone 22 is in a range of from 0% to 50% of the start-of-run catalytic activity of the catalyst in the catalyst zone 24. In a more preferred embodiment, the feed is first exposed to a grading material having a start-of-run catalytic activity that is in a range of from 0% to 30% and then to a different grading material having a start-of-run catalytic activity that is in a range of from 30% to 50%, relative to the start-of-run catalytic activity of the catalyst zone 24. This embodiment may be accomplished by layers, beds, or combination thereof in the grading zone of FIG. 2.

In the embodiment of FIG. 3, the feed is first exposed to first grading bed 26 and then to a second grading bed 28, where the start-of-run catalytic activity of the first grading bed 26 is less than the start-of-run catalytic activity of the second grading bed 28. In a preferred embodiment, the first grading bed 26 has a grading material with a start-of-run catalytic activity that is in a range of from 0% to 30% of the start-of-run catalytic activity of the catalyst zone 24, while the second grading bed 28 has a grading material with a start-of-run catalytic activity that is in a range of from 30% to 50%, relative to the start-of-run catalytic activity of the catalyst zone 24.

The catalytic activity of the material in the grading zone 22 may be reduced relative to the catalyst zone 24 by (i) increasing the particle size of the catalyst to reduce diffusion of the feedstock through the bed, (ii) increasing pore size and/or reducing pore volume of the catalyst to reduce the surface area available for catalytic reaction, and/or (iii) reducing the active metal loading on the catalyst. Examples of suitable grading material include inert and catalytically active shaped, high-void aluminas (for example, SENTRY OPTITRAP SERIES™ available from Shell as medallions, rings and lobes), Group VIII and/or Group VIB metals supported on larger particle size and/or larger pore size supports (for example, SENTRY INTERLAYER™ and SENTRYSUPPORT™ NiMo- and CoMo-promoted catalysts for grading between small diameter catalysts and larger reactor support media, and SENTRY MAXTRAP™).

The catalyst zone 24 favours hydroprocessing reactions including hydrogenation, hydrodeoxygenation, hydrodenitrogenation, hydrodesulphurization, hydrodemetalation, hydrocracking, hydroisomerization, and combinations thereof.

The hydroprocessing catalyst may be any catalyst known in the art that is suitable for hydroprocessing. Catalyst metals are often in an oxide state when charged to a reactor and preferably activated by reducing or sulphiding the metal oxide. Preferably, the hydroprocessing catalyst comprises catalytically active metals of Group VIII and/or Group VIB metals, including, without limitation, Pd, Pt, Ni, Co, Mo, W, and combinations thereof. Hydroprocessing catalysts are generally more active in a sulphided form as compared to an oxide form of the catalyst. A sulphiding procedure is used to transform the catalyst from a calcined oxide state to an active sulphided state. Catalyst may be pre-sulphided or sulphided in situ. Because renewable feedstocks generally have a low sulphur content, a sulphiding agent is often added to the feed to maintain the catalyst in a sulphided form.

As used herein, “start-of-run catalytic activity” means the activity of the catalyst on a volumetric basis when it is charged to the reactor and after the catalyst is activated, for example, by reduction or sulphiding, and conditioned.

Preferably, the hydroprocessing catalyst comprises sulphided catalytically active metals. Examples of suitable catalytically active metals include, without limitation, sulphided nickel, sulphided cobalt, sulphided molybdenum, sulphided tungsten, sulphided CoMo, sulphided NiMo, sulphided MoW, sulphided NiW, and combinations thereof. A catalyst bed/zone in the catalyst zone 24 may have a mixture of two types of catalysts and/or successive beds/zones, including stacked beds, and may have the same or different catalysts and/or catalyst mixtures. In case of such sulphided hydroprocessing catalyst, a sulphur source will typically be supplied to the hydroprocessing catalyst to keep the catalyst in sulphided form during the hydroprocessing step.

The hydrogenation components may be used in bulk metal form or the metals may be supported on a carrier. Suitable carriers include refractory oxides, molecular sieves, and combinations thereof. Examples of suitable refractory oxides include, without limitation, alumina, amorphous silica-alumina, titania, silica, and combinations thereof. Examples of suitable molecular sieves include, without limitation, zeolite Y, zeolite beta, ZSM-5, ZSM-12, ZSM-22, ZSM-23, ZSM-48, SAPO-11, SAPO-41, ferrierite, and combinations thereof.

As mentioned above, the hydroprocessing catalyst may be sulphided in-situ or ex-situ. In-situ sulphiding may be achieved by supplying a sulphur source, usually H₂S or an H₂S precursor (i.e. a compound that easily decomposes into H₂S such as, for example, dimethyl disulphide, di-tert-nonyl polysulphide or di-tert-butyl polysulphide) to the hydroprocessing catalyst during operation of the process. The sulphur source may be supplied with the feed, the hydrogen stream, or separately. An alternative suitable sulphur source is a sulphur-comprising hydrocarbon stream boiling in the diesel or kerosene boiling range that is co-fed with the feedstock. In addition, added sulphur compounds in feed facilitate the control of catalyst stability and may reduce hydrogen consumption.

Preferably, H₂S is provided to the reactor in an amount in the range of from 50 to 5,000 ppmv, preferably from 100 to 3,000 ppmv, more preferably from 500 to 2,000 ppmv. The amount of H₂S is dependent on a number of factors, including, for example, without limitation, type and amount of catalyst metal, operating temperature, other operating conditions, in the hydrotreating step.

Operating conditions in the hydroprocessing reactor include pressures in a range of from 1.0 MPa to 20 MPa, temperatures in a range of from 200 to 410° ° C. and liquid hourly space velocities in a range of from 0.3 m³/m³.h to 5 m³/m³.h based on fresh feed. Preferably, the pressure is selected from a pressure in the range of 2.0 MPa to 15 MPa. Preferably, the temperature is in the range of from 200 to 400° C.

The ratio of hydrogen to feed supplied in the fixed-bed reactor 12 is in a range of from 200 to 10,000 normal L (at standard conditions of 0° C. and 1 atm (0.101 MPa)) per kg of feed. Reference herein to feed is the total of fresh feedstock excluding any diluent that may be added.

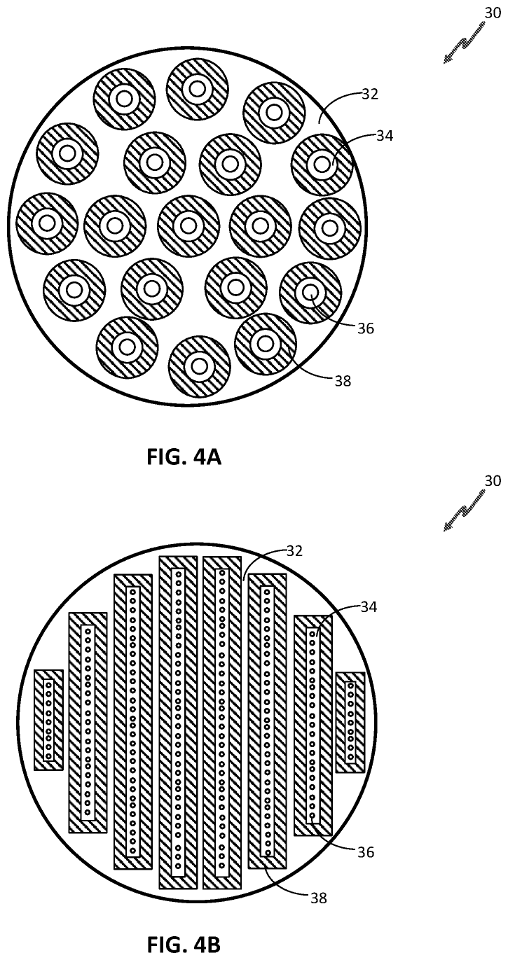

Embodiments of the filtering zone 30 are illustrated in FIGS. 4A-4B, 5A-5B and 6A-6B. It should be noted that the drawings are not necessarily to scale, for ease of discussion.

The filtering zone 30 of the present invention has interstitial portions 32 and annular portions 34. The interstitial portions 32 are substantially open to the space above the filtering zone 30. The annular portions 34 are substantially closed to direct downward flow of the feed stream 14. Conversely, the interstitial portions 32 are substantially closed to the headspace 16 above the catalytic zone 18, while the annular portions 34 are in fluid communication with the headspace 16 through openings 36. Advantageously, the openings 36 are formed in a support plate in a manner similar to a conventional catalyst bed support.

Referring now to FIGS. 4A and 4B, embodiments of configurations of the filtering zone 30 suitable for achieving the method of the present invention are illustrated. It will be understood by those skilled in the art that other shapes and configurations of the interstitial portions 32, annular portions 34, and openings 36 are possible, for practising the process of the present invention.

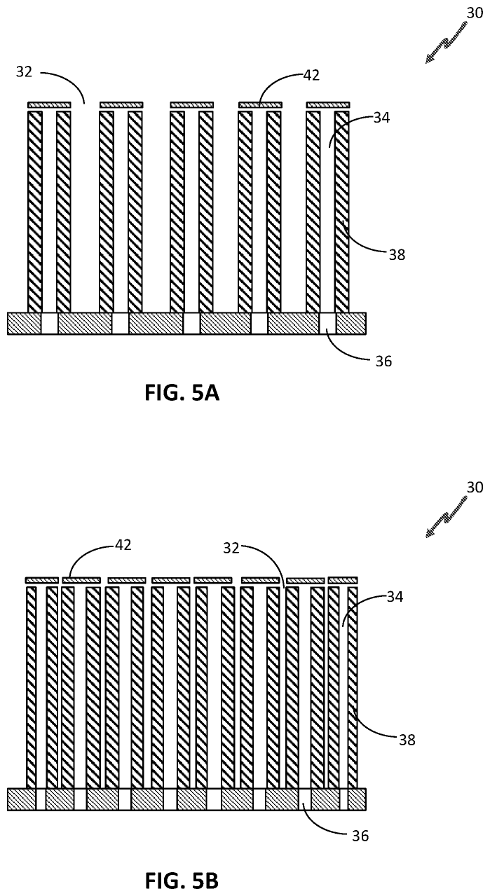

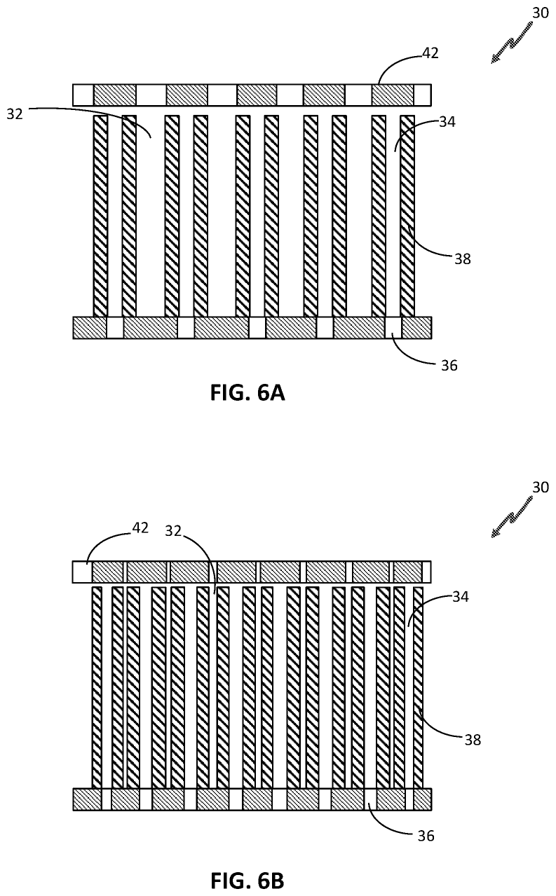

The feed stream 14 is directed from the inlet of the fixed-bed reactor 12 to the filtering zone 30, optionally, via a feed distributor (not shown). The feed stream 14 flows to the interstitial portions 32 either directly or by deflecting from a cover 42 at the top of the annular portions 34 (see FIGS. 5A-5B and 6A-6B). The feed stream 14 is then passed from the interstitial portions 32 to the annular portions 34 through a filtering material 38 disposed between the interstitial portions 32 and the annular portions 34.

The filtering material 38 is preferably a catalytically-inert material or a low-activity catalytic material. Suitable catalytically-inert materials including ceramics, metals, and combinations thereof. An especially suitable ceramic material is alumina. Advantageously, alumina may be formed with a desired porosity for offering even more surface area for capturing fouling and/or particulate matter. The low-activity catalytic material has a start-of-run catalytic activity that is at most 10% of the start-of-run catalytic activity of the catalyst in the catalyst zone 24. For example, in FIG. 4A, the filtering material 38 may be provided as discrete particles (including, without limitation, medallions, rings, spheres, lobes) that are contained between a pair concentric cylinders having perforated or mesh walls. An example of a suitable configuration of this type is illustrated in U.S. Pat. No. 10,562,002B2 (Maas et al., 18 Feb. 2020). Alternatively, the filtering material 38 may be provided as a hollow cylindrical monolith. Cylindrical embodiments of a container or monolith may be replaced with a hexagonal cross-section.

In the embodiment of FIG. 4B, the filtering material 38 is provided in a rectangular configuration. In one embodiment, discrete particles are contained within a cassette having perforated or mesh walls. In another embodiment, a hollow cuboid monolithic structure is used in the embodiment of FIG. 4B.

FIGS. 5A and 5B illustrate one embodiment of a cover 42 for each unit of filtering material 38. The cover 42 may be a supported flat cover as illustrated (supports not shown for ease of illustration) or a cap that has a downwardly depending portion. FIGS. 6A and 6B illustrate a cover 42 plate for the sacrificial fouling zone that mimics the bottom support plate but with openings that would preferentially feed the interstitial portions 32 and cover the annular portions 34. The purpose of the cover 42 is to substantially block direct feed flow into the annular portions 34, while allowing flow from the interstitial portions 32 to the annular portions 34 when the fouling and/or particulate matter builds up during operation, as will be explained in more detail below.

The structure of the filtering zone 30 is configured to provide increased surface area for fouling as compared with a typical catalyst bed in a fixed-bed reactor. For example, a catalyst bed in a 3 m inner diameter reactor would have a cross-sectional area of about 7 m². In the embodiment of FIG. 4A, the filtering zone 30 for a 3 m diameter reactor may have 52 cylinders having a diameter of 0.3 m. If, for example, each cylinder is 1 m tall, the available surface area for fouling would be increased to 52 m².

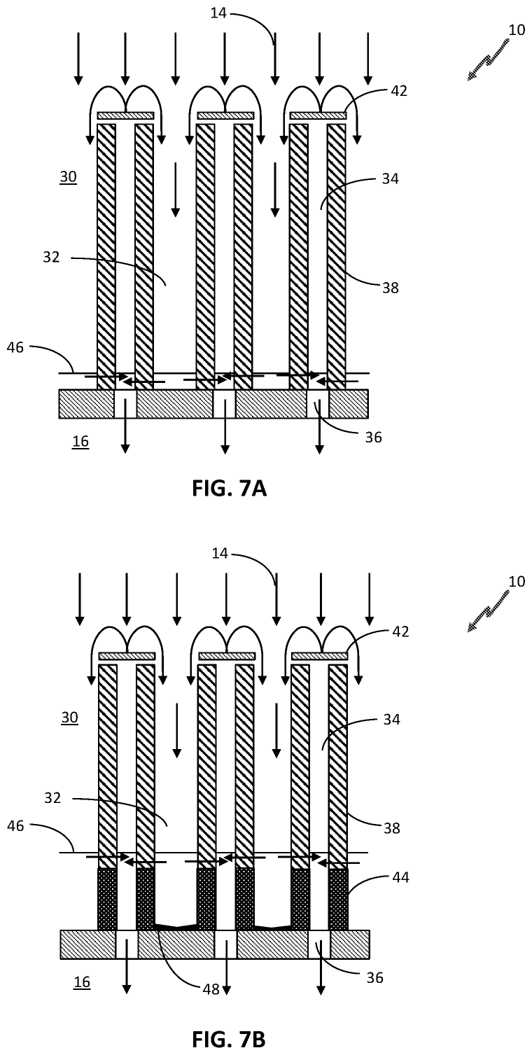

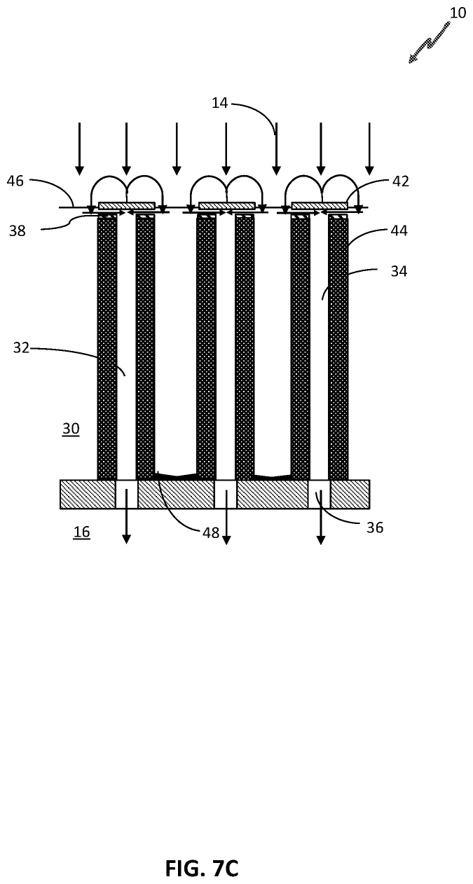

The process of the present invention is illustrated schematically in FIGS. 7A-7C. A feed stream 14 comprising renewable feedstock is introduced in a downward flow into a top portion of a fixed-bed reactor 12. The feed stream 14 is then directed to the interstitial portions 32 of the filtering zone 30 either by flowing directly into the interstitial portions 32 or by redirection caused by cover 42. Initially, as depicted in FIG. 7A, the feed freely flows to the bottom of the interstitial portions 32 and then passes through the filtering material 38 to the annular portions 34 with a liquid level 46. Filtered feed flows through openings 36 to the headspace 16 between the filtering zone 30 and the catalytic zone 18.

As operation progresses, products of fouling reactions and/or particulate matter produced during injection and/or introduced with the feed 14 are trapped by the voids in the filtering material 38. With time, lower portions of the filtering material 38 are plugged as depicted by the dotted sections 44 of the filtering material 38. In this way, flow of fouling and/or particulate matter to the catalytic zone 18 below is reduced. In addition to becoming trapped in the voids of the filtering material 38, depending on the feed properties. fouling/particulate matter 48 may also build up in the interstitial portions 32, as illustrated in FIG. 7B. Although voids in the lower portions of the filtering material 38 may be plugged to further flow, flow of feed through the upper portions of the filtering material 38 is not impeded and, therefore, an increase in pressure drop is reduced or avoided altogether. As depicted in FIG. 7B, the liquid level 46 rises as voids in the filtering material 38 become plugged with fouling/particulate matter. As the plugged portion 44 of the filtering material 38 is increased, as shown in FIG. 7C, the liquid level 46 further rises and flow through the filtering material 38 is reduced further, until finally, feed preferentially flows through the space between the cover 42 and the filtering material 38. Further fouling and/or particulate matter now passes through the openings 36 to the headspace 16 above the catalytic zone 18.

In the preferred embodiment of FIG. 2, the catalytic zone 18 has a grading zone 22 above the catalyst zone 24. When the filtered feed 14 passes through the openings 36 to the headspace 16, the filtered feed is then directed to the grading zone 22. The grading zone 22, having a lower start-of-run catalytic activity relative to the catalyst zone 24, causes some hydroprocessing reactions to occur, but at a reduced rate relative to the catalyst zone 24.

While the catalytic zone 18 may be subjected to fouling once the voids of the filtering material 38 are fully blocked by fouling/particulate matter, the active life of the catalyst in the reactor has increased significantly in accordance with the present invention. By reducing fouling over catalytic zone, the rate of pressure drop build-up is reduced, thereby improving the length of catalyst active life and energy efficiency. Furthermore, operational downtime is significantly reduced in accordance with the present invention.

While the embodiments are described with reference to various implementations and exploitations, it will be understood that these embodiments are illustrative and that the scope of the inventive subject matter is not limited to them. Many variations, modifications, additions and improvements are possible. For example, one or more image may be performed using one or more of the techniques herein. Various combinations of the techniques provided herein may be used.

1. A process for hydroprocessing a renewable feedstock in a fixed-bed reactor system having at least one catalytic bed, the process comprising the steps of:
introducing a renewable feedstock in a downward flow into a top portion of a fixed-bed reactor;
directing the downward flow of the renewable feedstock to a filtering zone having top-open interstitial portions to receive the downward flow and top-covered annular portions that are in fluid communication with a headspace between the filtering zone and a catalytic zone;
passing the downward flow from the interstitial portions to the annular portions through a filtering material disposed between the interstitial portions and the annular portions, resulting in a filtered feedstock;
allowing the filtered feedstock to flow downwardly to the catalytic zone; and
reacting the filtered feedstock in the catalytic zone under hydroprocessing conditions sufficient to cause a reaction selected from the group consisting of hydrogenation, hydrodeoxygenation, hydrodenitrogenation, hydrodesulphurization, hydrodemetalation, hydrocracking, hydroisomerization, and combinations thereof.

2. The process of claim 1, wherein the catalytic zone comprises a grading zone and a catalyst zone.

3. The process of claim 2, wherein the grading zone has a start-of-run catalytic activity in a range of from 0 to 50% of the start-of-run catalytic activity of the catalyst in the catalyst zone.

4. The process of claim 3, wherein the grading zone has a first grading bed and a second grading bed, wherein the start-of-run catalytic activity of the first grading bed is less than the start-of-run catalytic activity of the second grading bed.

5. The process of claim 4, wherein the first grading bed has a start-of-run catalytic activity in a range of from 0 to 30% of the start-of-run catalytic activity of the catalyst in the catalyst zone, and the second grading bed has a start-of-run catalytic activity in a range of from 30 to 50% of the start-of-run catalytic activity of the catalyst in the catalyst zone.

6. The process of claim 1, wherein the renewable feedstock is selected from the group consisting of one or more bio-renewable fats and oils, liquid derived from a biomass liquefaction process, liquid derived from a waste liquefaction process, and combinations thereof.

7. The process of claim 1, further comprising the step of distributing the downward flow of the renewable feedstock with a feed distributor in the top portion of the fixed-bed reactor above the filtering zone.

8. The process of claim 1, further comprising adding a petroleum-derived feedstock for co-processing with the renewable feedstock, preferably in an amount to produce a feed stream comprising from 30 to 99 wt. % renewable feedstock, preferably from 40 to 99 wt. % renewable feedstock.

9. The process of claim 1, wherein hydrogen is mixed with the renewable feedstock prior to the introducing step.

10. The process of claim 1, wherein the filtering material is selected from the group consisting of ceramics, preferably alumina, metals, and combinations thereof.

11. The process of claim 2, wherein the grading zone is comprised up catalytically inert material, catalytically active material, and combinations thereof.

12. The process of claim 1, wherein the interstitial portions are substantially closed to the headspace between the filtering zone and the catalytic zone.

13. The process of claim 1, wherein the hydroprocessing conditions at least comprise a process temperature in the range of from 200 to 400° C.
